(19) United States
(12) Patent Application Publication
(10) Pub. No.: US 2014/0028221 A1
(43) Pub. Date: Jan. 30, 2014

(54) Method of Adaptively Tuning Motor Speed

(71) Applicants: Sawyer I. Cohen, Sunnyvale, CA (US); Yehonatan Perez, Menlo Park, CA (US)

(72) Inventors: Sawyer I. Cohen, Sunnyvale, CA (US); Yehonatan Perez, Menlo Park, CA (US)

(73) Assignee: Apple Inc., Cupertino, CA (US)

(21) Appl. No.: 13/557,205

(22) Filed: Jul. 24, 2012

(51) Int. Cl. H02P 7/00

(52) U.S. Cl. 318/114

(57) ABSTRACT

Methods and apparatuses related to adaptively tuning vibratory motors are disclosed. One embodiment takes the form of a method of adaptively tuning a vibratory motor including operating the motor at a plurality of voltage levels and recording the frequency of operation of the motor at each of the plurality of voltage levels. The method also includes creating a curve based on the recorded frequency and voltage levels and selecting a drive voltage based upon an intersection of a desired frequency of operation and the created curve.

### TECHNOLOGICAL FIELD

The present invention is generally related to haptic devices and, more particularly, to tuning of motor speed to improve haptic feedback.

### BACKGROUND

Rotary vibration motors have a wide variation in speed due to mechanical differences. Typical variation of vibration motors is +/−30% of nominal speed. Vibration speed affects the sound of the vibration motor as well as the amount of force that it imparts to a user. This variation in speed is magnified in haptic devices because the tactile feedback felt by a user is the acceleration of the motor. For a rotating counterweight motor the acceleration is generally related to the rotation frequency squared. As such, the difference felt by a user between two motors used for haptic feedback may be significant due to variation in the frequency of operation.

### SUMMARY

Methods and apparatuses for adaptively tuning vibratory motor speed are discussed herein. One embodiment takes the form of a method of adaptively tuning a vibratory motor including operating the motor at a plurality of voltage levels and recording the frequency of operation of the motor at each of the plurality of voltage levels. The method also includes creating a curve based on the recorded frequency and voltage levels and selecting a drive voltage based upon an intersection of a desired frequency of operation and the created curve.

Another embodiment may take the form of an electronic device having a vibratory motor and a processor in communication with the vibratory motor. The processor is configured to drive the motor with a drive voltage. The electronic device also includes one or more sensors for determining a frequency of operation of the vibratory motor.

The processor is configured to determine if the frequency of operation is within an acceptable range of a desired operating frequency and, if not, adjust the drive voltage.

Yet another embodiment may take the form of a method of operating an electronic device including driving a motor at a first voltage level and determining an operating frequency of the motor. The method also includes comparing the operating frequency with a desired frequency and, if the operating frequency is not within an acceptable range of the desired frequency, adjusting the drive voltage to a second voltage level.

While multiple embodiments are disclosed, still other embodiments of the present invention will become apparent to those skilled in the art from the following Detailed Description. As will be realized, the embodiments are capable of modifications in various aspects, all without departing from the spirit and scope of the embodiments. Accordingly, the drawings and detailed description are to be regarded as illustrative in nature and not restrictive.

### BRIEF DESCRIPTION OF THE DRAWINGS

FIG. 1 illustrates an example electronic device.

FIG. 2 is a block diagram of the electronic device of FIG. 1.

FIG. 3 is a flowchart illustrating an example method of tuning a vibratory motor.

FIG. 4 illustrates a Plot A illustrating acceleration versus frequency of the motor and Plot B illustrating drive voltage versus frequency of the motor.

FIG. 5 illustrates line fitting a curve to collected operating frequency data points.

FIG. 6 illustrates Plot C of acceleration data in the time domain and Plot D of the data after performing a fast-Fourier transform to find a frequency peak.

FIG. 7 is a flowchart illustrating another example method of tuning a vibratory motor in accordance with an alternative embodiment.

FIG. 8 is a flowchart illustrating yet another example method of tuning a vibratory motor in accordance with yet another alternative embodiment.

FIG. 9 illustrates a linear vibratory motor.

FIG. 10 illustrates and example operating curve for a linear vibratory motor created using collected frequency data points.

### DETAILED DESCRIPTION

Embodiments may generally take the form of apparatuses and methods for adaptively tuning vibratory motor speed. The motor speed tuning may be performed by a motor vendor prior to the motor being sold or installed into an electronic device, by an electronics manufacturer before or after the motor is installed into an electronic device and/or by the device itself while the device is in service and being used by an end-user. As such, the motor may be tuned one time, multiple times and/or continuously throughout its life.

The tuning of the motor by the motor vendor may be a non-contextual tuning. That is, the tuning is performed independent of an operating context in which the motor may be used. The motor is operated at two or more different voltage levels and the speed at which the motor operates for each voltage level is recorded. The voltage levels and speeds are used to extrapolate drive voltages that achieve a desired speed for the motor. The drive voltage may be recorded on the motor (or a label for the motor) using a scannable code. Upon installation into an electronic device, the code may be read and used to program the electronic device for proper operation of the motor. Specifically, the code may be read and the operating voltage may be recorded into the devices system configuration dataset.

Another embodiment may take the form of a method for tuning the motor when it is installed in an electronic device, for example by an electronics device manufacturer. Initially, the motor is installed into the device and driven at two or more different voltages and the speeds at which the motor operates is recorded for each voltage. The speed data points are used to create a curve which may be used to determine a voltage level that will achieve a desired speed. The motor is then driven with that voltage and the speed of the motor is recorded to verify that the voltage achieves the desired speed. The drive voltage is then stored in the devices system configuration and referenced to drive the motor at the desired speed when the motor is operated.

Yet another embodiment may take the form of a method of continuous or periodic tuning of the motor speed while the motor is in use by an end user. One or more of the prior described methods may be utilized to set an initial or baseline drive voltage and/or operating speed of the motor. One or more onboard sensors may be used to monitor the speed of the motor when it operates. Typically, the sensors data will be evaluated after an initial warm up period for the motor (e.g., approximately 80 milliseconds). A feedback control loop is used to adjust the drive voltage and, hence, the speed of the motor based on the sensor data to maintain operation of the motor at the desired speed. Thus, small changes in the speed of the motor due to age or damage may be accounted for by the device and the motor may continue to operate as desired.

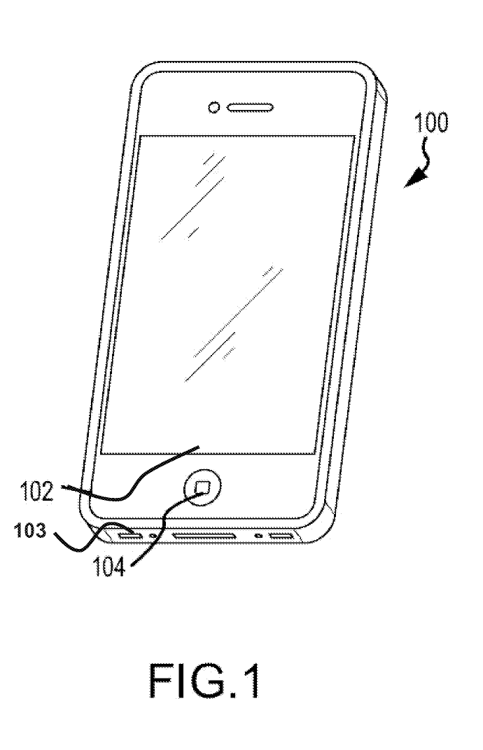

Turning to the drawings and referring initially to FIG. 1, an example electronic device 100 is illustrated. The illustrated electronic device 100 is a smart phone, such as the iPhone® manufactured by Apple, Inc. It should be appreciated that the device 100 is merely provided as an example and the present techniques may be implemented for motors installed in various different devices and in a variety of different contexts. Some example devices in which the present techniques may be implemented include a tablet computer, a cell phone, a remote control, a video game controller, and so forth.

The electronic device 100 may include one or more input and output devices including, but not limited to a display 102, one or more microphones 103, and one or more buttons and/or switches 104. Additionally, the display 102 may be configured as a touch sensitive display, such as a capacitive touch display to receive user input. The electronic device 100 may also include one or more haptic devices that may be utilized to provide tactile feedback to a user. For example, a motor may drive an eccentric weight to cause vibration. The vibration may be felt by the user.

Generally, the operation of the haptic device may serve as an alert to the user. For example, the haptic device may operate when a text, phone call, or email is received by the electronic device. Additionally, the haptic device may operate as an alarm. Further, the haptic device may operate during execution of a particular program or application to indicate a certain action or event has occurred. For example in a word game, the haptic device may operate to indicate a time limit has expired, or an incorrect or correct answer has been given. As such, the haptic device may be utilized in a variety of different contexts and for a variety of different purposes.

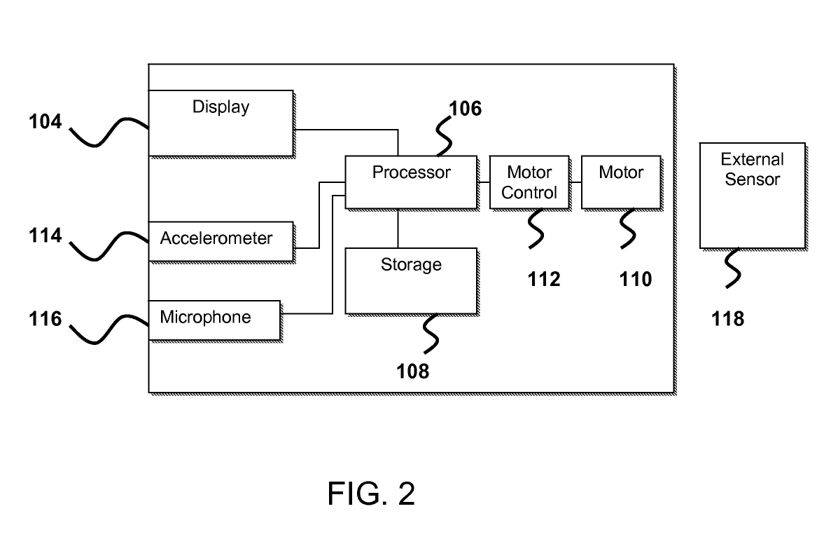

FIG. 2 is a block diagram of the electronic device 100. The device 100 includes a processor 106 and a computer readable storage medium 108 coupled to the processor 106. The computer readable storage medium 108 may store operating instructions or programming code that may be executed by the processor 106 to dictate the functions of the device 100. For example, the instructions may dictate the operation of a vibration motor 110, including when it actuates and the drive voltage that is provided to the motor to operate the motor.

In some embodiments, a motor control 112 may be coupled between the motor 110 and the processor 106. In some embodiments, the motor controller 112 may control the actuation of the motor 110 based on signals from the processor 102. Specifically, the motor controller 112 may provide the drive voltage for the motor 110. Further, the motor controller 112 may store information related to the operation of the motor including, but not limited to actuation patterns and driving voltages to achieve desired speeds of operation.

Additionally, the electronic device 100 may include one or more sensors configured to sense the operation of the vibration motor 110 to determine an operating speed of the motor. Some example sensors include an accelerometer 114 and a microphone 116 that measures the frequency of the motor 110. In some embodiments, microphone 116 and microphone 103 may be the same microphone. In other embodiments, one may be internal and the other external to the device housing.

It should be appreciated that other sensors may also or alternatively be provided and serve this purpose. For example, an external microphone, an external accelerometer that is positioned on the device or plugs into the device, an external laser vibrometer, a hall effect sensor, and so forth. As such, sensors internal to and/or external to the device 100 may be used to measure the speed of the motor. The external sensor 118 may take the form of one of the aforementioned sensors or another suitable sensor.

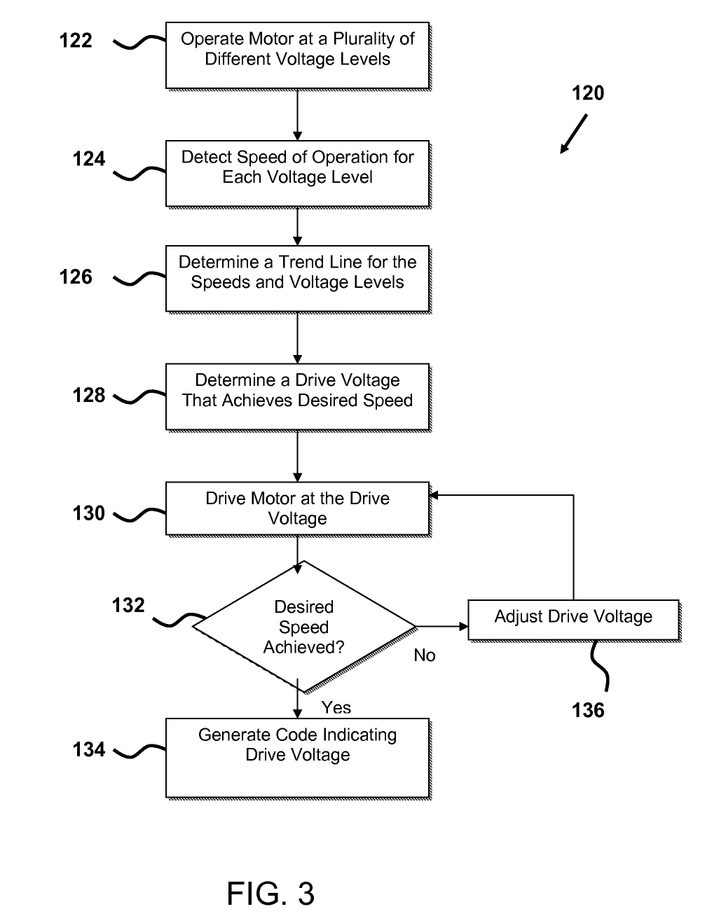

The tuning of the motor speed may be performed at different stages of the motor's life. FIG. 3 is a flowchart illustrating a method 120 of tuning a motor prior to the motor being installed in a device. As such, the method 120 may generally be performed by a motor manufacturer or an electronic device manufacturer.

The method 120 generally includes operating the motor at two or more different voltages (Block 122). One or more sensors detect the speed at which the motor operates for each drive voltage (Block 124). The speeds are recorded and a trend line is determined (Block 126). A drive voltage that correlates to a desired motor speed is extrapolated from the recorded speed and voltage data (Block 128). The motor is then driven at the voltage that is extrapolated from the data (Block 130) and it is determined if the desired speed is achieved (Block 132).

If the desired speed is achieved, the drive voltage that achieved the desired speed may be encoded and a code may be provided on the motor that indicates the drive voltage (Block 134). In some embodiments, if the speed of the motor is within a threshold distance of the desired speed, it may be deemed sufficient for the purposes of the motor. For example, in some embodiments, a deviation from the desired speed of +/−10 Hz may be sufficiently close to the desired speed that the drive voltage is deemed to have achieved the desired speed.

If, however, the desired speed is not achieved, the drive voltage may be adjusted either upwardly or downwardly (Block 136). The new drive voltage is then tested to see if the motor operates at the desired speed or if it is within an acceptable range of the desired speed (Block 132). In some embodiments, if the desired speed is achieved, the drive voltage that achieved the desired speed may be encoded and a code may be provided on the motor that indicates the drive voltage (Block 134). The code may be read by an electronic device manufacture to program the operation of the motor when the motor is installed in a device.

It should be appreciated that some motors may be defective and may not operate properly. A defective motor may be determined when the motor is unable to achieve the desired speed after a certain number of iterations of trying to achieve the desired speed. That is, if the motor is unable to reach and/or sustain the desired speed after the drive voltage has been adjust at least once to try to achieve the desired speed, and then it may be deemed defective and discarded. In some embodiments, the drive voltage may be adjusted three or more times before the motor is deemed defective. In other embodiments, the motor may be deemed defective if an operational curve for the motor is non-linear, as discussed in greater detail below.

In some embodiments, the adjustment of the drive voltage may be determined based, at least in part, upon a magnitude of deviation from the desired speed. That is, if the speed is 50 Hz deviated from the desired speed the drive voltage may be adjusted in an amount greater than that if the speed were only 20 Hz deviated from the desired speed. In some embodiments, a ratio based adjustment may be made. As such, the voltage may be adjusted based on the ratio of the achieved speed relative to the desired speed. For example, if the ratio of the achieved speed to desired speed is 0.8, the drive voltage may be increased by 20%. Further, in other embodiments, the drive voltage may be increased or decreased a set amount for each iteration of the method 120. For example, the voltage may be increased or decreased in 10 mV steps, or some other suitable step size.

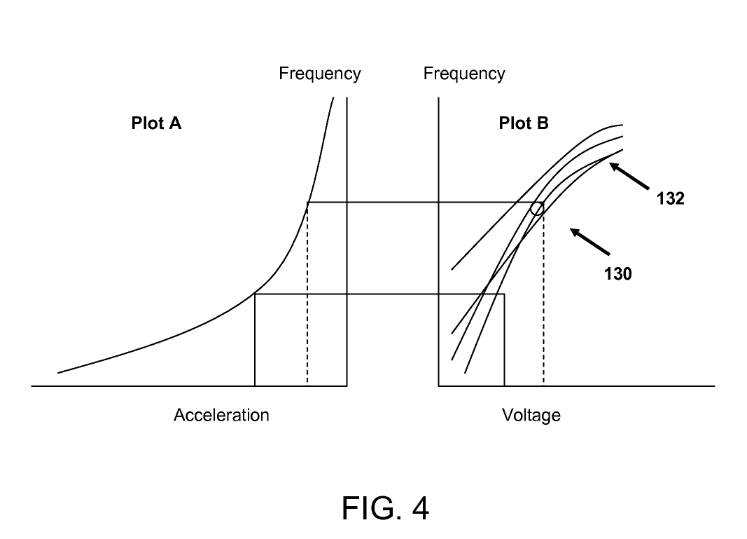

As may be appreciated, the accelerometer (and/or other sensors) may measure the acceleration of the motor. The acceleration of the motor is related to the frequency of the motor as shown in Plot A on the left-side of FIG. 4. As mentioned above, this acceleration is what is felt by the user of a device. Additionally, the frequency of rotation of the motor is related to the average voltage supplied to the motor as shown in Plot B located on the right-side of FIG. 4. In Plot B, multiple lines 130 are shown to illustrate each motor having a unique curve. Due to the high variance in each motor, each motor may have a slightly different curve defining its operation relative to other motors. Indeed, each motor may have a unique curve that represents its operation. As such, as each motor is driven at the same voltage, they will each map to a different acceleration in Plot A. Generally, a single acceleration and frequency curve (e.g., Plot A) may be representative of all the motors. It should be appreciated that there may be slight variances between acceleration and frequency curves for each of the motors.

Additionally, as may be seen in Plot B of FIG. 4, each curve representing operation of a motor is generally linear up to a certain voltage level at which point the curves flatten out and the frequency of operation no longer increases as the voltage increases. This is because the motors have a maximum operational frequency and the flattened portion 132 represents the maximum frequency level of the motors.

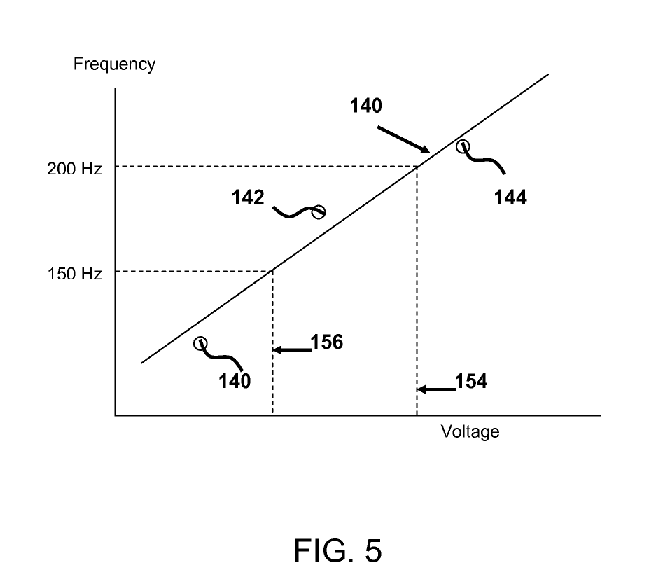

Generally, accelerometers may measure the acceleration in three axes and one or more sets of measurements (e.g., from one or more axes) may be used to determine the frequency of rotation for the motor. In one example, the frequency of rotation for the motor is measured for three discrete voltages (e.g., low, medium and high voltage levels) 140, 142, 144. A linear fit function is applied to the three data points to form a line 146, as shown in FIG. 5.

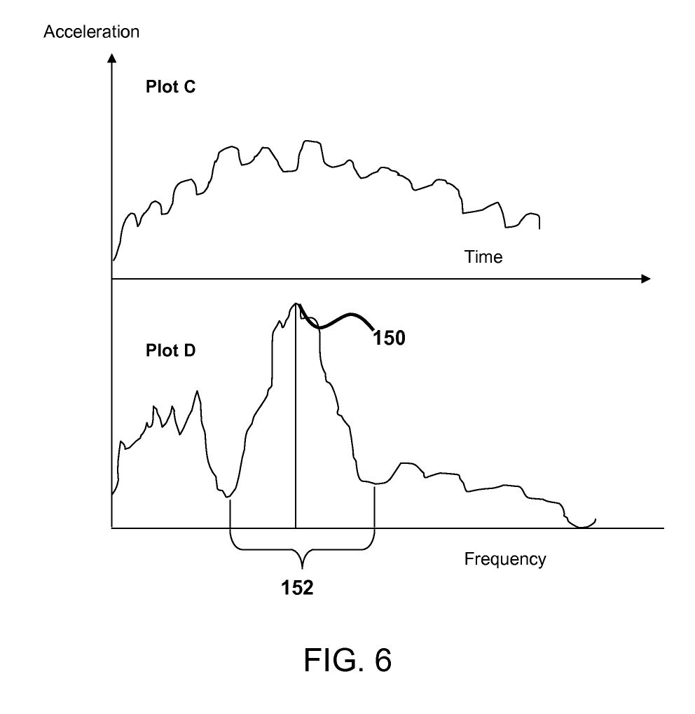

To find the frequency of rotation from the accelerometer data, a fast-Fourier transform (FFT) is performed on the accelerometer data. FIG. 6 illustrates the FFT performed on accelerometer data. A Plot C (e.g., the upper portion of FIG. 6) illustrates the accelerometer data in the time domain, with time being the horizontal axis and the vertical axis being the acceleration as measured by the accelerometer.

In Plot D (e.g., the lower portion of FIG. 6), the frequency domain is illustrated with frequency being the horizontal axis after the FFT is performed. A frequency peak 150 is obtained from this data. This peak 150 corresponds to the frequency of rotation of the motor for the driving voltage. In some embodiments, only a portion (e.g., portion 152) of the spectrum in Plot D may be searched for a peak so that noise that may contain false peaks may be eliminated. The range of frequencies that are searched may vary, but may generally include a range of frequencies spanning +/−40 Hz about an expected peak frequency. In other embodiments, the frequency range may be narrower or broader.

Referring again to FIG. 5, the linearity of the curve generated by the three data points 140, 142, 144 may be evaluated for quality control purposes. In particular, if the three data points 140, 142, 144 do not form a good line, and then it may indicate that the motor is bad. In some embodiments, the distance of the line from each of the points may be evaluated to make a determination as to whether the motor is defective. Further, in some embodiments, a slope of the line generated by the points may be evaluated to determine if the motor is bad. For example, if the curve is too flat (e.g., the slope falls below a threshold value) the motor may be deemed defective.

In other embodiments, a non-linear curve may be used to define the relationship between the data points. As such, the line or curve 146 representing the points 140, 142, 144 need not be linear in some embodiments.

The curve 146 generated by the data points 140, 142, 144 is used to determine the drive voltages that provide desired frequency and, hence, the acceleration output for haptic feedback to a user. In some embodiments, one or more drive voltages may be selected. For example, a strong drive voltage 154 and a weak drive voltage 156 (in FIG. 5) may be designated. The strong drive voltage may correspond to a voltage that achieves an approximately 200 Hz frequency of rotation for the motor and a weak voltage may correspond to a voltage that achieves an approximately 150 Hz frequency of rotation for the motor. The strong and weak voltages may each be stored in memory of an electronic device to be retrieved upon operation of the motor. The device may be user configurable to determine when one or the other is to be used.

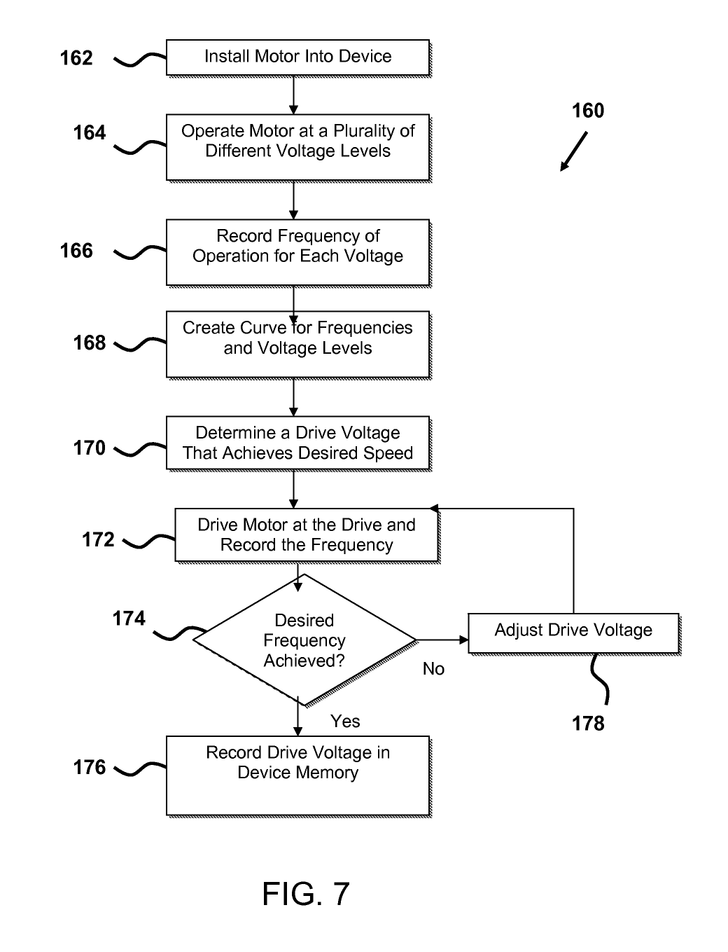

FIG. 7 is a flowchart illustrating a method 160 of tuning the motor in accordance with an alternative embodiment. In particular, the method 160 may be performed by an electronic device manufacturer when installing the motor in an electronic device. Generally, method 160 includes installing the motor in the device (Block 162) and driving the motor at two or more different voltages (Block 164). The frequency of rotation of the motor at the different voltages are recorded (Block 166) and used to create a speed/voltage curve for the device and motor combination (Block 168). The techniques discussed above may be implemented to translate the accelerometer or other data to frequency data for the purposes of generating the curve. In some embodiments, however, the frequency may be measured directly. For example, a microphone, hall effect sensor, laser vibrometer, and so forth may measure the frequency directly.

The speed/voltage curve is used to extrapolate or interpolate a drive voltage that achieves a desired frequency of rotation (Block 170). The motor is then driven at the determined drive voltage and the frequency is recorded (Block 172). It is then determined if the desired frequency was achieved (Block 174). If the desired frequency was achieved, then the drive voltage is recorded in the device memory as part of the system configuration dataset and called up for operation of the motor (Block 176). If, however, the desired frequency is not reached, then the drive voltage is adjusted (Block 178) and the motor is driven using the adjusted drive voltage (Block 172) and the process continues.

It should be appreciated that multiple drive frequencies may be determined and saved in the memory of the device following method 160. For example, the strong and weak drive voltages discussed above may be determined and saved in the device's memory.

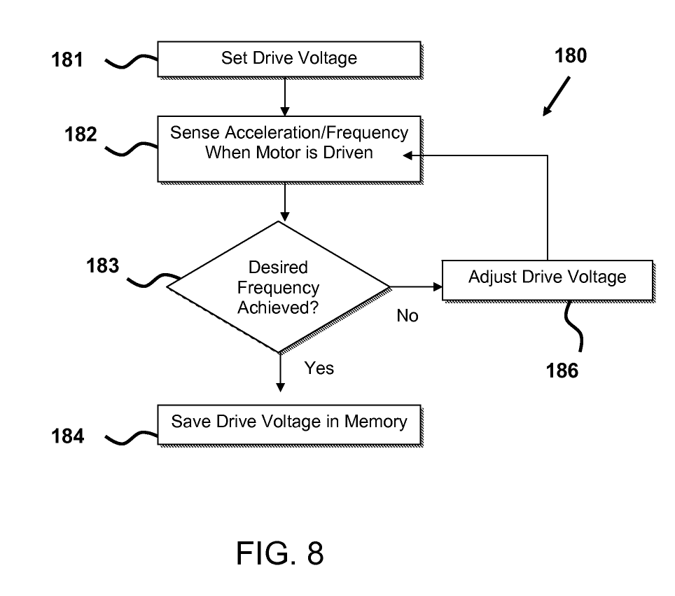

FIG. 8 is a flowchart illustrating another method 180 of tuning the motor in accordance with yet another alternative embodiment. The method 180 is performed by the device itself and may be performed periodically, intermittently, or frequently throughout the life of the device to help ensure effective operation of the motor. The method 180 may account for small changes in the speed of the motor that occur over time when the motor runs. It can also account for and make appropriate adjustments for changes in speed due to damage to the motor, such as damage incurred from a drop or sudden impact.

The method 180 may include setting an initial drive voltage (Block 181) which may be set following the steps of method 160 or any other suitable method. In some embodiments, the initial drive voltage may be pre-selected and the same for all devices. An onboard accelerometer and/or microphone monitors the speed of the motor when it is actuated (Block 182). Generally, the accelerometer and/or microphone may provide data or recorded data after the motor has exceeded a speed-up period of approximately 80 milliseconds). A control loop adjusts the drive voltage of the motor to slowly change the speed of the motor to a desired speed over the course of multiple motor actuations. Specifically, it is determined if the motor is operating at the desired frequency (Block 183). If so, then the drive voltage is stored in memory (Block 184). If not, the drive voltage is adjusted (Block 186) and the motor is driven with the adjusted drive voltage when the motor is driven again (Block 182). The control loop may take any suitable form and in one embodiment may take the form of a proportional-integral-derivative (PID) control loop. Additionally, the adjustment of the drive voltage may occur over a period of days, depending upon the number of times during a day that the motor operates. It should be appreciated that when using an onboard accelerometer to measure the frequency of the vibrator motor, the accelerometer data may be processed as described above so as to filter out the frequency components that are present due to the normal motion of the device by the user. These components will typically be concentrated at lower frequencies below 50 Hz or so. Thus the normal use of the device does not interfere with the adaptive tuning of the vibrator motor.

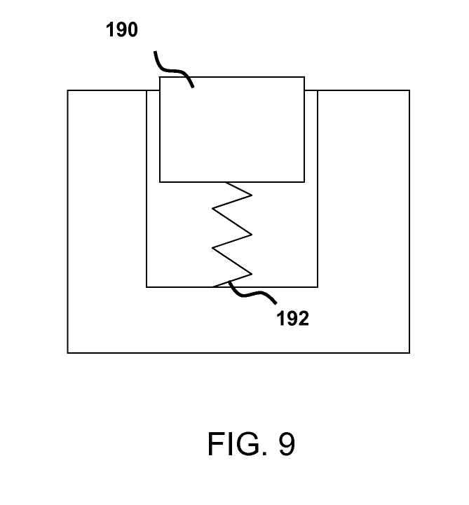

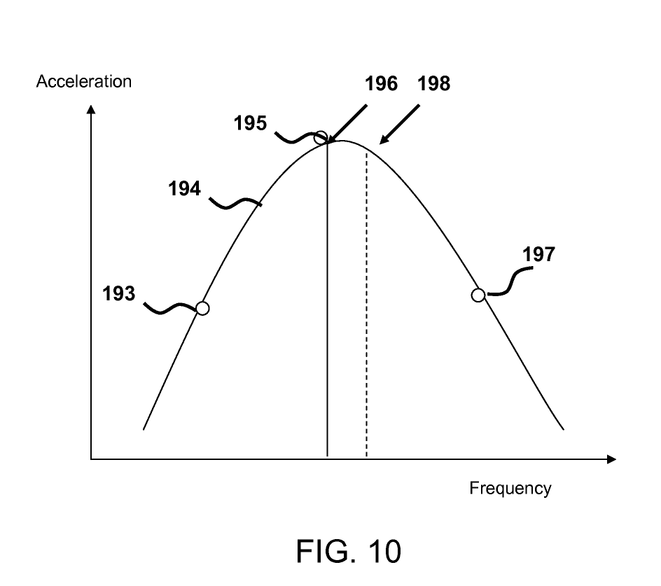

It should be appreciated that one or more of the foregoing methods and techniques may be implemented for calibration or and/or quality control of linear vibration devices, such as linear haptic feedback devices. Generally, a linear vibration device include a mass 190 mounted on a spring 192, as shown in FIG. 9. The mass 190 is moved in a linear manner to generate vibration. Linear drive motor may be driven with an ac voltage at different frequencies 193, 195, 197 to get a curve 194 of acceleration magnitude versus frequency as shown in FIG. 10. The curve 194 is evaluated to determine if the peak 196 of the curve is within an acceptable range of a desired peak 198. The frequency that provides the maximal or other desired acceleration can be programmed into the device for future use. This will reduce part to part variation in the acceleration felt by the user. It will also ensure maximum energy efficiency as the maximum force is generated for a given input power. The acceleration can be measured similarly by an accelerometer and using an Fast Fourier Transform to detect the magnitude of the acceleration at the drive frequency and filter out components that are not related to the vibration of the motor. This type of calibration can be done in a controlled environment where the device is placed at rest to help avoid fluctuation of the recorded acceleration values.

Although the foregoing discussion has presented specific embodiments, persons skilled in the art will recognize that changes may be made in form and detail without departing from the spirit and scope of the embodiments. Accordingly, the specific embodiments described herein should be understood as examples and not limiting the scope thereof.

1. A method of adaptively tuning a vibratory motor comprising:
operating the motor at a plurality of voltage levels;
recording the frequency of operation of the motor at each of the plurality of voltage levels;
creating a curve based on the recorded frequency and voltage levels; and
selecting a drive voltage based upon an intersection of a desired frequency of operation and the created curve.

2. The method of claim 1 further comprising:
generating a code which communicates the drive voltage; and
associating the code with the motor.

3. The method of claim 1 further comprising:
saving the drive voltage in a memory of an electronic device; and
retrieving the drive voltage to operate the motor.

4. The method of claim 1 further comprising:
operating the motor using the drive voltage;
determining if the motor operates at a desired frequency; and
if so, saving the drive voltage in a memory of an electronic device.

5. The method of claim 4, wherein if the motor does not operate at the desired frequency:
the drive voltage is adjusted;
the motor is operated using the adjusted drive voltage; and
if the motor operates at the desired frequency with the adjusted drive voltage, saving the adjusted drive voltage in the memory of the electronic device.

6. The method of claim 1, wherein the frequency of operation is determined by:
performing a fast-Fourier transform (FFT) on sensor data to convert the data from the time domain to the frequency domain; and
selecting a peak from the frequency domain.

7. The method of claim 6, wherein the peak is selected from a subset of the frequency spectrum generated by the FFT.

8. The method of claim 1, wherein the curve comprises a straight line.

9. The method of claim 8, further comprising:
determining a slope of the line; and if the slope is less than a threshold value, deeming the motor defective.

10. The method of claim 1, wherein the curve is not a straight line.

11. The method of claim 1, further comprising:
determining a distance between a data point and the curve; and
if the distance is greater than a threshold, deeming the motor defective.

12. The method of claim 1, wherein the frequency of operation is sensed by at least one of:
a microphone;
a hall effect sensor; or a laser vibrometer.

13. An electronic device comprising:
a vibratory motor;
a processor in communication with the vibratory motor, the processor configured to drive the motor with a drive voltage; and
one or more sensors for determining a frequency of operation of the vibratory motor, wherein the processor is configured to determine if the frequency of operation is within an acceptable range of a desired operating frequency and if not, adjust the drive voltage.

14. The electronic device of claim 13, further comprising a memory in communication with the processor, wherein the memory stores the drive voltage and, wherein further, the processor replaces the stored drive voltage with an adjusted drive voltage if the drive voltage is adjusted.

15. The electronic device of claim 13, wherein the one or more sensors comprise at least one of:
an accelerometer;
a microphone;
a hall effect sensor; or
a laser vibrometer.

16. The electronic device of claim 13, wherein the motor is encoded with a drive voltage.

17. The electronic device of claim 13 further comprising a motor controller, wherein the motor controller is configured to provide the drive voltage to the motor.

18. A method of operating an electronic device comprising:
driving a motor at a first voltage level;
determining an operating frequency of the motor;
comparing the operating frequency with a desired frequency; and
if the operating frequency is not within an acceptable range of the desired frequency, adjusting the drive voltage to a second voltage level.

19. The method of claim 18, wherein the operating frequency is determined by one of a microphone or an accelerometer, and the operating frequency is determined after a speed-up period has passed.

20. The method of claim 18, wherein the drive voltage is adjusted using a control loop over a period of days.
